(19) United States
(12) Patent Application Publication
(10) Pub. No.: US 2026/0218019 A1
(43) Pub. Date: Jul. 30, 2026

(54) Set Of Aqueous Adhesive Compositions And Transport Belt

(71) Applicant: SEIKO EPSON CORPORATION, Tokyo (JP)

(72) Inventors: Nikako TSUKIJI, Matsumoto (JP); Koichi TERAO, Suwa (JP); Soichi YAMAZAKI, Shiojiri (JP); Harunobu KOMATSU, Matsumoto (JP)

(21) Appl. No.: 19/457,692

(22) Filed: Jan. 23, 2026

(30) Foreign Application Priority Data
Jan. 24, 2025 (JP) 2025-010651

(51) Int. Cl. C09J 133/06; B41J 3/407; B41J 15/04; D06P 5/30

(52) U.S. Cl. CPC C09J 133/064; B41J 3/4078; B41J 15/048; D06P 5/30

(57) ABSTRACT

A set of aqueous adhesive compositions for forming an adhesive layer on a surface of a transport member of an ink jet textile printing apparatus, which transports a fabric, includes a first aqueous adhesive composition and a second aqueous adhesive composition, in which the adhesive layer includes a first adhesive layer laminated on the transport member and containing the first aqueous adhesive composition, and a second adhesive layer laminated on the first adhesive layer and containing the second aqueous adhesive composition, the second aqueous adhesive composition contains water and a second (meth)acrylic resin, the second (meth)acrylic resin has 50% to 98% by mass of a constitutional unit derived from a specific (meth)acrylate represented by Formula (1) with respect to a total amount of the second (meth)acrylic resin, the second (meth)acrylic resin has a glass transition temperature of −30° C. to −7° C., the first aqueous adhesive composition contains water and a first (meth)acrylic resin, and the first (meth)acrylic resin has a glass transition temperature higher than the glass transition temperature of the second (meth)acrylic resin.

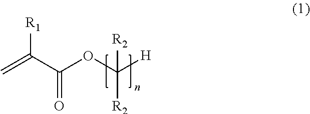

(In Formula (1), R₁ represents a hydrogen atom or a methyl group, and a plurality of R₂'s each independently represent a hydrogen atom, a methyl group, or an ethyl group. Further, n represents a natural number of 4 to 12.)

The present application is based on, and claims priority from JP Application Serial Number 2025-010651, filed Jan. 24, 2025, the disclosure of which is hereby incorporated by reference herein in its entirety.

### BACKGROUND

### 1. Technical Field

The present disclosure relates to a set of aqueous adhesive compositions and a transport belt.

### 2. Related Art

An ink jet recording method enables recording of a high-definition image with a relatively simple device, and enables rapid development to be achieved in various fields. Under the above-described circumstances, various research is conducted on textile recording using a fabric as a recording medium. For example, JP-A-2021-109736 discloses an adhesive layer removal device including a solvent coating section that coats a surface of a belt on which an adhesive layer is formed with a solvent for dissolving the adhesive layer, and a swelling promoting section that promotes swelling of the adhesive layer due to permeation of the solvent.

In an ink jet textile printing apparatus of the related art, an adhesive layer is formed at a transport member such as an endless belt, a fabric serving as a recording medium is attached to the adhesive layer, the fabric is transported to a printing section to perform recording, and the transport member and the fabric are peeled off to perform printing. Since the adhesive layer for the fabric and the transport member is formed at the surface of the transport member, the surface of the transport member has adhesiveness.

The ink, the lint, and other remaining members adhering to the transport member in the printing step remain on the transport member from which the fabric is peeled off. Therefore, these remaining members are required to be removed before attachment of the fabric again. The remaining members such as the ink and the lint adhering to the transport member are typically washed with water. When the remaining members are washed, a brush, a sponge, or the like that cleans the transport member may be used. Further, when the adhesive force of the adhesive layer decreases, the old adhesive layer is removed from the surface of the transport member, and then a new adhesive layer is formed.

As the adhesive layer used for the ink jet textile printing, a layer obtained by dissolving a hydrophobic resin in an organic solvent is usually used to endure washing with water. Further, when the adhesive layer for which an organic solvent is used is peeled off, an organic solvent is usually used as a release agent. However, in order to reduce the environmental load and improve the work environment, there is a demand for an aqueous adhesive composition having a small amount of an organic solvent to be used or an aqueous adhesive composition used for an adhesive layer that can reduce the amount of an organic solvent to be used during peeling.

### SUMMARY

According to an aspect of the present disclosure, there is provided a set of aqueous adhesive compositions for forming an adhesive layer on a surface of a transport member of an ink jet textile printing apparatus, which transports a fabric, the set including: a first aqueous adhesive composition; and a second aqueous adhesive composition, in which the adhesive layer includes a first adhesive layer laminated on the transport member and containing the first aqueous adhesive composition, and a second adhesive layer laminated on the first adhesive layer and containing the second aqueous adhesive composition, the second aqueous adhesive composition contains water and a second (meth)acrylic resin, the second (meth)acrylic resin has 50% to 98% by mass of a constitutional unit derived from a specific (meth)acrylate represented by Formula (1) with respect to a total amount of the second (meth)acrylic resin, the second (meth)acrylic resin has a glass transition temperature of −30° C. to −7° C., the first aqueous adhesive composition contains water and a first (meth)acrylic resin, and the first (meth)acrylic resin has a glass transition temperature higher than the glass transition temperature of the second (meth)acrylic resin.

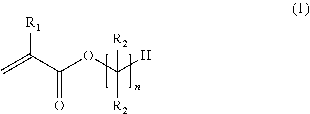

In Formula (1), R₁ represents a hydrogen atom or a methyl group, and a plurality of R₂'s each independently represent a hydrogen atom, a methyl group, or an ethyl group. In addition, n represents a natural number of 4 to 12.

According to another aspect of the present disclosure, there is provided a transport belt including in the following order: a transport member; a first adhesive layer; and a second adhesive layer, in which the second adhesive layer contains a second aqueous adhesive composition, the second aqueous adhesive composition contains water and a second (meth)acrylic resin, the second (meth)acrylic resin has 50% to 98% by mass of a constitutional unit derived from a specific (meth)acrylate represented by Formula (1) with respect to a total amount of the second (meth)acrylic resin, the second (meth)acrylic resin has a glass transition temperature of −30° C. to −7° C., the first adhesive layer contains a first aqueous adhesive composition, the first aqueous adhesive composition contains water and a first (meth)acrylic resin, and the first (meth)acrylic resin has a glass transition temperature higher than the glass transition temperature of the second (meth)acrylic resin.

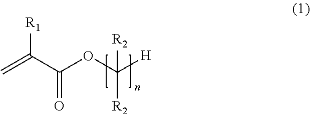

In Formula (1), R₁ represents a hydrogen atom or a methyl group, and a plurality of R₂'s each independently represent a hydrogen atom, a methyl group, or an ethyl group. In addition, n represents a natural number of 4 to 12.

### BRIEF DESCRIPTION OF THE DRAWINGS

FIG. 1 is a schematic view showing a recording apparatus that is used in the present embodiment.

FIG. 2 is a schematic cross-sectional view showing a transport belt of the present embodiment.

FIG. 3 is a table listing examples and comparative examples.

FIG. 4 is a table listing examples and comparative examples.

### DESCRIPTION OF EMBODIMENTS

Hereinafter, an embodiment of the present disclosure (hereinafter, referred to as “the present embodiment”) will be described in detail with reference to the accompanying drawings, but the present disclosure is not limited thereto, and various modifications can be made within a range not departing from the scope of the present disclosure. In the drawings, the same elements are denoted by the same reference numerals and the repetitive description will be omitted. Further, the positional relationships, such as the left, the right, the top, and the bottom, are based on the positional relationships shown in the drawings unless otherwise specified. In addition, the dimensional ratios in the drawings are not limited to ratios shown in the drawings.

The term “(meth)acrylate” is a generic expression of an acrylate and a methacrylate. Further, the term “unit” such as “constitutional unit” or “(meth)acrylate unit” denotes a repeating unit derived from a monomer when the monomer is polymerized into a polymer.

### 1. Set of Aqueous Adhesive Compositions

A set of aqueous adhesive compositions of the present embodiment (hereinafter, simply also referred to as “set”) is a set of aqueous adhesive compositions for forming an adhesive layer on a surface of a transport member of an ink jet textile printing apparatus, which transports a fabric, the set including: a first aqueous adhesive composition; and a second aqueous adhesive composition, in which the adhesive layer includes a first adhesive layer laminated on the transport member and containing the first aqueous adhesive composition, and a second adhesive layer laminated on the first adhesive layer and containing the second aqueous adhesive composition, the second aqueous adhesive composition contains water and a second (meth)acrylic resin, the second (meth)acrylic resin has 50% to 98% by mass of a constitutional unit derived from a specific (meth)acrylate represented by Formula (1) with respect to a total amount of the second (meth)acrylic resin, the second (meth)acrylic resin has a glass transition temperature of −30° C. to −7° C., the first aqueous adhesive composition contains water and a first (meth)acrylic resin, and the first (meth)acrylic resin has a glass transition temperature higher than the glass transition temperature of the second (meth)acrylic resin.

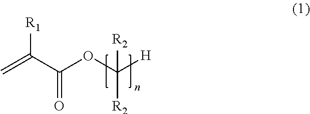

In Formula (1), R₁ represents a hydrogen atom or a methyl group, and a plurality of R₂'s each independently represent a hydrogen atom, a methyl group, or an ethyl group. In addition, n represents a natural number of 4 to 12.

The set of the present embodiment is aqueous, and when the set is used, the environmental load is reduced and the working environment is improved as compared with a case where an oily adhesive is used.

In addition, the second aqueous adhesive composition of the set of the present embodiment contains a second (meth)acrylic resin having 50% to 98% by mass of a constitutional unit derived from the specific (meth)acrylate with respect to the total amount of the second (meth)acrylic resin. In the specific (meth)acrylate, when n represents 4 or greater, the adhesiveness of the second adhesive layer forming the surface of the adhesive layer and containing the second aqueous adhesive composition is improved, and the fabric tends to suitably adhere and fix to the adhesive layer. Further, when n represents 12 or less, the cohesive force between the polymers having a constitutional unit derived from the specific (meth)acrylate is improved, and the component peeled off from the second adhesive layer tends to be prevented from remaining on the fabric, that is, the fabric tends to be prevented from being contaminated. Further, since n represents 12 or less, the second adhesive layer tends to be prevented from being scratched or peeled off when the adhesive layer is washed, that is, washability of the second adhesive layer tends to be improved. In addition, when the second (meth)acrylic resin contains 50% to 98% by mass of the specific (meth)acrylate, the adhesiveness and the washability of the second adhesive layer tend to be improved, and the fabric tends to be prevented from being contaminated. Further, since the second (meth)acrylic resin has a glass transition temperature of −30° C. or higher, the second aqueous adhesive composition tends to have moderate hardness, and the fabric can be prevented from being contaminated. In addition, since the second (meth)acrylic resin has a glass transition temperature of −7° C. or lower, the second aqueous adhesive composition has moderate softness, and the adhesiveness of the second adhesive layer tends to be improved.

In the related art, when the adhesive layer formed of a resin having a Tg of about −30° C. to −7° C. is peeled off from the transport member, the adhesive force of the adhesive layer is high, and an organic solvent is usually used. In this regard, the first aqueous adhesive composition of the set of the present embodiment contains the first (meth)acrylic resin having a glass transition temperature higher than that of the second (meth)acrylic resin. In this manner, when the adhesive layer on the transport member is replaced for washing, the first adhesive layer containing the first aqueous adhesive composition is suitably peeled off from the transport member, that is, the easy replacement property of the adhesive layer including the first adhesive layer tends to be improved. As described above, the adhesive layer including the first adhesive layer and the second adhesive layer, which is formed by using the set of the present embodiment is excellent in the adhesiveness, the washability, and the easy replacement property of the adhesive layer, and the fabric adhering to the adhesive layer tends to be prevented from being contaminated.

In addition, in the first aqueous adhesive composition and the second aqueous adhesive composition, the (meth)acrylic resin tends to be stably dispersed in water. That is, the first aqueous adhesive composition and the second aqueous adhesive composition tend to have satisfactory water dispersion stability.

Hereinafter, each configuration that can be included in the set of the present embodiment will be described in detail.

### 1.1. First Aqueous Adhesive Composition

The first aqueous adhesive composition contains water and a first (meth)acrylic resin, and may contain a surfactant, a pH adjuster, and other additives. Hereinafter, each component that can be included in the first aqueous adhesive composition will be described in detail.

1.1.1. First (meth)acrylic Resin

The first (meth)acrylic resin may be a water-soluble resin or resin particles dispersed in an aqueous solvent. These are also collectively referred to as the first (meth)acrylic resin in the present embodiment. Further, the resin particles dispersed in the aqueous solvent are also referred to as an aqueous dispersion of a resin.

The first (meth)acrylic resin has a glass transition temperature higher than the glass transition temperature of the second (meth)acrylic resin described below. The glass transition temperature of the first (meth)acrylic resin is preferably −10 to 0° C., more preferably −7 to 0° C., and still more preferably −7 to −2° C. When the glass transition temperature thereof is −7° C. or higher, the easy replacement property of the adhesive layer tends to be further improved. In addition, when the glass transition temperature thereof is 0° C. or lower, the adhesiveness between the first adhesive layer and the transport member tends to be sufficient.

The glass transition temperature (Tg) of the (meth)acrylic resin can be adjusted, for example, by adjusting the type of monomer constituting the (meth)acrylic resin. Specifically, the (meth)acrylic resin has constitutional units derived from a monomer having a large molecular weight, a monomer having a double bond or a triple bond, a monomer having a large side chain such as an aromatic ring, a monomer containing a terminal group that is a functional group having polarity, and the like, and thus the movement of the polymer chain is restricted, and the Tg tends to be increased.

The glass transition temperature of the (meth)acrylic resin can be measured by a method known in the related art using differential scanning calorimetry (DSC).

When the first aqueous adhesive composition contains resin particles containing the first (meth)acrylic resin, the median diameter of the resin particles is preferably 50 to 300 nm, more preferably 100 to 300 nm, and still more preferably 150 to 300 nm. In this manner, the easy replacement property of the adhesive layer tends to be further improved. The median diameter denotes the median diameter of the volume distribution measured by a laser diffraction/scattering method, and is the size of a particle that exactly indicates 50% of the median value cumulatively when a large number of measurement results are expressed as a cumulative abundance ratio for each size.

The content of the first (meth)acrylic resin is preferably 20% to 80% by mass, more preferably 30% to 60% by mass, and still more preferably 40% to 60% by mass with respect to the total amount of the first aqueous adhesive composition. In this manner, the easy replacement property of the adhesive layer tends to be further improved.

The first (meth)acrylic resin is obtained by polymerizing a (meth)acrylate as a monomer, and has a constitutional unit derived from a (meth)acrylate. In addition, the first (meth)acrylic resin may be a copolymer of, in addition to a (meth)acrylate, an allyl monomer such as allyl alcohol, a vinyl monomer such as styrene, and monomers other than a (meth)acrylate such as (meth)acrylic acid. Examples of the (meth)acrylate include a monofunctional (meth)acrylate and a polyfunctional (meth)acrylate.

The acid value of the first (meth)acrylic resin is preferably 5 to 10 mgKOH/g. In this manner, the easy replacement property of the adhesive layer tends to be further improved.

The acid value of the first (meth)acrylic resin is not particularly limited, but can be adjusted, for example, by adjusting the type of monomer to be used. Specifically, the acid value can be increased by using a monomer containing a carboxyl group.

1.1.1.1. Monofunctional (meth)acrylate

The first (meth)acrylic resin has a constitutional unit derived from a monofunctional (meth)acrylate, and thus the adhesiveness between the first adhesive layer and the second adhesive layer tends to be improved.

The monofunctional (meth)acrylate is not particularly limited, and examples thereof include aromatic group-containing monofunctional (meth)acrylates such as phenoxyethyl (meth)acrylate, benzyl (meth)acrylate, alkoxylated 2-phenoxyethyl (meth)acrylate, ethoxylated nonylphenyl (meth)acrylate, alkoxylated nonylphenyl (meth)acrylate, p-cumylphenol EO-modified (meth)acrylate, and 2-hydroxy-3-phenoxypropyl (meth)acrylate, alicyclic group-containing monofunctional (meth)acrylates such as isobornyl (meth)acrylate (IBXA), tert-butylcyclohexanol acrylate (TBCHA), and 2-(meth)acrylic acid-1,4-dioxaspiro[4,5]dec-2-ylmethyl, linear or branched aliphatic group-containing monofunctional (meth)acrylates such as methyl (meth)acrylate, ethyl (meth)acrylate, t-butyl (meth)acrylate, i-butyl (meth)acrylate, butyl (meth)acrylate, isoamyl (meth)acrylate, cyclohexyl (meth)acrylate, 2-ethylhexyl (meth)acrylate, stearyl (meth)acrylate, lauryl (meth)acrylate, octyl (meth)acrylate, decyl (meth)acrylate, isodecyl (meth)acrylate, isomyristyl (meth)acrylate, isostearyl (meth)acrylate, 2-hydroxybutyl (meth)acrylate, butoxyethyl (meth)acrylate, tetrahydrofurfuryl (meth)acrylate, 2-hydroxyethyl (meth)acrylate, and 2-hydroxypropyl (meth)acrylate, and lactone-modified flexible (meth)acrylate. The monofunctional (meth)acrylate may be used alone or in combination of two or more kinds thereof.

The content of the constitutional unit derived from the monofunctional (meth)acrylate is preferably 80.0% by mass or greater and 100.0% by mass or less, more preferably 85.0% by mass or greater and 100.0% by mass or less, and still more preferably 90.0% by mass or greater and 100.0% by mass or less with respect to the total amount of the first (meth)acrylic resin. In this manner, the adhesive layer tends to have an excellent easy replacement property of the adhesive layer while the washability is maintained.

1.1.1.2. Polyfunctional (meth)acrylate

The polyfunctional (meth)acrylate is not particularly limited, and examples thereof include bifunctional (meth)acrylates such as 1,6-hexanediol di(meth)acrylate, 3-methyl-1,5-pentanediol di(meth)acrylate, 1,3-propanediol di(meth)acrylate, 1,10-decanediol di(meth)acrylate, tetraethylene glycol di(meth)acrylate, tripropylene glycol di(meth)acrylate, neopentyl glycol di(meth)acrylate, 1,4-butanediol di(meth)acrylate, diethylene glycol di(meth)acrylate, 1,3-butanediol di(meth)acrylate, 1,9-nonanediol di(meth)acrylate, 4,4′-biphenol di(meth)acrylate, ethylene glycol di(meth)acrylate, and triethylene glycol di(meth)acrylate, and trifunctional or higher polyfunctional (meth)acrylates such as trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, tri(meth)acrylic acid glycerin, glycerin propoxy tri(meth)acrylate, caprolactone-modified trimethylolpropane tri(meth)acrylate, pentaerythritol ethoxytetra(meth)acrylate, and caprolactam-modified dipentaerythritol hexa(meth)acrylate. The polyfunctional (meth)acrylate may be used alone or in combination of two or more kinds thereof.

The first (meth)acrylic resin may or may not have a constitutional unit derived from a polyfunctional (meth)acrylate, and when the first (meth)acrylic resin has a constitutional unit derived from a polyfunctional (meth)acrylate, the content thereof is not particularly limited, but is, for example, 0.1% to 2.0% by mass with respect to the total amount of the first (meth)acrylic resin.

### 1.1.2. Surfactant

The first aqueous adhesive composition may contain a surfactant. The surfactant is not particularly limited, and examples thereof include an anionic surfactant, a nonionic surfactant, and a cationic surfactant. The surfactant may be used alone or in combination of two or more kinds thereof.

Examples of the anionic surfactant include polyoxyethylene lauryl ether, an alkyl sulfocarboxylate, an alkyl diphenyl ether disulfonate, an α-olefin sulfonate, a polyoxyethylene alkyl ether acetate, N-acylamino acid and a salt thereof, an N-acylmethyl taurine salt, an alkyl sulfate such as ammonium lauryl sulfate, sodium lauryl sulfate, or sodium dodecyl sulfate, a polyoxyalkyl ether sulfate, a polyoxyethylene alkyl ether phosphate, rosin acid soap, castor oil sulfate, lauryl alcohol sulfate, alkylphenol type phosphate, alkyl type phosphate, an alkylaryl sulfonate, a diethyl sulfosuccinate, a diethyl hexyl sulfosuccinate, and a dioctyl sulfosuccinate.

Examples of the nonionic surfactant include an acetylene glycol-based surfactant, a silicone-based surfactant, polyoxyethylene alkyl ether, polyoxyethylene alkyl phenyl ether, polyoxyethylene fatty acid ester, polyoxyethylene hardened castor oil, propylene glycol fatty acid ester, glycerin fatty acid ester, polyglycerin fatty acid ester, sorbitan fatty acid ester, sucrose fatty acid ester, alkyl polyglycoside, alkyl diethanolamide, and alkyl amine oxide.

Examples of the cationic surfactant include alkylamine salts, fatty acid amidoamine salts, monoalkyl quaternary ammonium salts, dialkyl quaternary ammonium salts, trialkyl quaternary ammonium salts, benzalkonium quaternary ammonium salts, benzetonium chloride, and alkylpyridinium salts.

The content of the surfactant is not particularly limited, but is, for example, 1.0% to 5.0% by mass with respect to the total amount of the first (meth)acrylic resin. In addition, the content of the surfactant is not particularly limited, but is, for example, 0.5% to 2.5% by mass with respect to the total amount of the first aqueous adhesive composition.

### 1.1.3. pH Adjuster

The first aqueous adhesive composition may contain a pH adjuster. The pH adjuster is not particularly limited, but examples thereof include an inorganic acid (for example, sulfuric acid, hydrochloric acid, or nitric acid), an inorganic base (for example, lithium hydroxide, sodium hydroxide, potassium hydroxide, ammonia, or an ammonium salt), an organic base (triethanolamine, diethanolamine, monoethanolamine, or tripropanolamine), and an organic acid (for example, adipic acid, citric acid, or succinic acid). The pH adjuster may be used alone or in combination of two or more kinds thereof.

Among these, ammonia or an ammonium salt is preferable. Ammonia is volatilized during formation of the adhesive layer and the first (meth)acrylic resins are likely to adhere to each other, by using such a pH adjuster, and thus a coating film into which water is difficult to enter is formed. Therefore, the durability of the adhesive force and the water resistance of the adhesive layer tend to be improved, and the adhesiveness tends to be maintained in a wide temperature range.

The content of the pH adjuster is not particularly limited, but is, for example, 0.05% to 1.50% by mass with respect to the total amount of the first aqueous adhesive composition. The first aqueous adhesive composition may contain the pH adjuster such that the pH of the first aqueous adhesive composition is 8.0 to 9.0. In this manner, the durability of the adhesive force and the water resistance are improved, and the adhesiveness tends to be maintained in a wide temperature range.

### 1.1.4. Water

The content of water is preferably 30% to 80% by mass, more preferably 35% to 70% by mass, and still more preferably 40% to 60% by mass with respect to the total amount of the first aqueous adhesive composition.

### 1.1.5. Organic Solvent

From the viewpoint of reducing the environmental load or the influence on a human body, it is preferable that the first aqueous adhesive composition contains no organic solvent. In addition, when the first aqueous adhesive composition contains an organic solvent, the content of the organic solvent is preferably 5.0% by mass or less, more preferably 2.5% by mass or less, and still more preferably 1.0% by mass or less with respect to the total amount of the first aqueous adhesive composition. In this manner, the environmental load can be reduced, the amount of volatile organic compounds (VOC) during the use of the first aqueous adhesive composition can be reduced, and thus the work environment tends to be further improved.

### 1.1.6. Other Additives

The first aqueous adhesive composition may contain additives other than each of the components described above. The other additives are not particularly limited, and examples thereof include an emulsifier and a coloring material. The content of the other additives is not particularly limited, but is, for example, 0.1% to 5.0% by mass with respect to the total amount of the first aqueous adhesive composition.

### 1.1.7. Method of Producing First Aqueous Adhesive Composition

The first aqueous adhesive composition is not particularly limited, and is obtained, for example, by dissolving or dispersing a resin obtained by polymerizing the above-described monomer and, as necessary, other components in water. Alternatively, the aqueous adhesive composition is obtained by dissolving or dispersing a resin prepared in advance and, as necessary, other components in water.

The polymerization method is not particularly limited, but for example, the monomer and the surfactant may be mixed and stirred in water, and a polymerization initiator such as ammonium persulfate may be added to the obtained mixed liquid to polymerize the monomer. During the polymerization reaction, the mixed liquid may be heated to a temperature range of 50° C. to 90° C. After the polymerization reaction is completed, the mixed liquid may be cooled, and water and a pH adjuster may be added to the mixed liquid during cooling. In this manner, an aqueous dispersion of the resin is obtained.

The obtained aqueous dispersion of the resin may be used as the first aqueous adhesive composition, or the first aqueous adhesive composition may be obtained by adding the other additives or the like to the aqueous dispersion of the resin.

### 1.2. Second Aqueous Adhesive Composition

The second aqueous adhesive composition may contain water and a second (meth)acrylic resin, and may further contain a surfactant, a pH adjuster, and other additives. Hereinafter, each component that can be contained in the second aqueous adhesive composition will be described in detail.

1.2.1. Second (meth)acrylic Resin

The second (meth)acrylic resin may be a water-soluble resin or resin particles dispersed in an aqueous solvent. These are also collectively referred to as a second (meta)acrylic resin in the present embodiment. Further, the resin particles dispersed in the aqueous solvent are also referred to as an aqueous dispersion of a resin.

The glass transition temperature of the second (meth)acrylic resin is −30 to −7° C. and preferably −30 to −10° C. In this manner, the adhesiveness of the second adhesive layer tends to be further improved.

When the second aqueous adhesive composition contains resin particles containing a second (meth)acrylic resin, the median diameter of the resin particles is preferably 100 to 250 nm and more preferably 150 to 250 nm. In this manner, the water dispersion stability of the second (meth)acrylic resin tends to be improved.

The content of the second (meth)acrylic resin is preferably 20% to 80% by mass, more preferably 30% to 60% by mass, and still more preferably 40% to 60% by mass with respect to the total amount of the second aqueous adhesive composition. In this manner, the adhesiveness of the second adhesive layer tends to be further improved.

The second (meth)acrylic resin is obtained by polymerizing a (meth)acrylate as a monomer, and has a constitutional unit derived from a (meth)acrylate. In addition, the second (meth)acrylic resin may be obtained by copolymerizing, in addition to a (meth)acrylate, an allyl monomer such as an allyl alcohol, a vinyl monomer such as styrene, and monomers other than the (meth)acrylate, such as (meth)acrylic acid.

It is preferable that the second (meth)acrylic resin contains a carboxyl group. In this manner, the cohesive force between the polymers in the second (meth)acrylic resin is improved, and the washability of the second adhesive layer tends to be further improved.

In addition, the acid value of the second (meth)acrylic resin is preferably 5 to 10 mgKOH/g. When the acid value thereof is 5 mgKOH/g or greater, the water dispersion stability of the second (meth)acrylic resin tends to be improved. In addition, when the acid value thereof is 10 mgKOH/g or less, the washability of the second adhesive layer tends to be further improved.

The acid value of the second (meth)acrylic resin is not particularly limited, but can be adjusted, for example, by adjusting the type of monomer to be used. Specifically, the acid value can be increased by using a monomer containing a carboxyl group.

The second (meth)acrylic resin may have a constitutional unit derived from the specific (meth)acrylate represented by Formula (1) and other constitutional units derived from a (meth)acrylate.

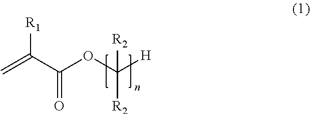

In Formula (1), R₁ represents a hydrogen atom or a methyl group, and a plurality of R₂'s each independently represent a hydrogen atom, a methyl group, or an ethyl group. In addition, n represents a natural number of 4 to 12.

The specific (meth)acrylate may be used alone or in combination of two or more kinds thereof.

1.2.1.1. Specific (meth)acrylate

In Formula (1), n represents preferably 4 to 10 and more preferably 4 to 8. In this manner, the adhesiveness of the second adhesive layer is further improved, and the washability of the second adhesive layer tends to be further improved.

Specific examples of the specific (meth)acrylate include butyl (meth)acrylate, 2-ethylhexyl (meth)acrylate, lauryl (meth)acrylate, 3-methylbutyl (meth)acrylate, 2,2′-dimethylpentyl (meth)acrylate, undecyl (meth)acrylate, decyl (meth)acrylate, nonanyl (meth)acrylate, octyl (meth)acrylate, heptyl (meth)acrylate, hexyl (meth)acrylate, and pentyl (meth)acrylate.

The content of the constitutional unit derived from the specific (meth)acrylate is 50% to 98% by mass, preferably 50% to 95% by mass, and more preferably 50% to 90% by mass with respect to the total amount of the second (meth)acrylic resin. In this manner, the adhesiveness of the second adhesive layer is further improved, and the washability of the second adhesive layer tends to be further improved.

1.2.1.2. Other (meth)acrylates

Examples of other (meth)acrylates include monofunctional (meth)acrylates and polyfunctional (meth)acrylates.

1.2.1.2.1. Monofunctional (meth)acrylate

The second (meth)acrylic resin has a constitutional unit derived from a monofunctional (meth)acrylate, and thus the adhesiveness of the second adhesive layer tends to be further improved.

The monofunctional (meth)acrylate is not particularly limited, and the examples described as the monofunctional (meth)acrylate of the first (meth)acrylic resin can be used.

The content of the constitutional unit derived from a monofunctional (meth)acrylate is preferably 1% to 50% by mass, more preferably 5% to 50% by mass, and still more preferably 10% to 50% by mass with respect to the total amount of the second (meth)acrylic resin. In this manner, the adhesiveness of the second adhesive layer tends to be further improved.

1.2.1.2.2. Polyfunctional (meth)acrylate

The polyfunctional (meth)acrylate is not particularly limited, and the examples described as the polyfunctional (meth)acrylate of the first (meth)acrylic resin can be used.

The second (meth)acrylic resin may or may not have a constitutional unit derived from a polyfunctional (meth)acrylate, and when the second (meth)acrylic resin has a constitutional unit derived from a polyfunctional (meth)acrylate, the content thereof is not particularly limited, but is, for example, 0.1% to 2.0% by mass with respect to the total amount of the second (meth)acrylic resin.

### 1.2.2. Surfactant

The second aqueous adhesive composition may contain a surfactant. The surfactant is not particularly limited, and for example, the surfactants described in the section of the first aqueous adhesive composition can be used. The content of the surfactant is not particularly limited, but is, for example, 1.0% to 5.0% by mass with respect to the total amount of the second (meth)acrylic resin. In addition, the content of the surfactant is not particularly limited, but is, for example, 0.5% to 2.5% by mass with respect to the total amount of the second aqueous adhesive composition.

### 1.2.3. pH Adjuster

The second aqueous adhesive composition may contain a pH adjuster. The pH adjuster is not particularly limited, and for example, the pH adjusters described in the section of the first aqueous adhesive composition can be used. The content of the pH adjuster is not particularly limited, but is, for example, 0.05% to 1.50% by mass with respect to the total amount of the second aqueous adhesive composition. The second aqueous adhesive composition may contain the pH adjuster such that the pH thereof is 8.0 to 9.0. In this manner, the durability of the adhesive force and the water resistance are improved, and the adhesiveness tends to be maintained in a wide temperature range.

### 1.2.4. Water

The content of the water is preferably 30% to 80% by mass, more preferably 35% to 70% by mass, and still more preferably 40% to 60% by mass with respect to the total amount of the second aqueous adhesive composition.

### 1.2.5. Organic Solvent

From the viewpoint of reducing the environmental load or the influence on a human body, it is preferable that the second aqueous adhesive composition contains no organic solvent. In addition, when the second aqueous adhesive composition contains an organic solvent, the content of the organic solvent is preferably 5.0% by mass or less, more preferably 2.5% by mass or less, and still more preferably 1.0% by mass or less with respect to the total amount of the second aqueous adhesive composition. In this manner, the environmental load can be reduced, the amount of volatile organic compounds (VOC) during the use of the second aqueous adhesive composition can be reduced, and thus the work environment tends to be further improved.

### 1.2.6. Other Additives

The second aqueous adhesive composition may contain additives other than each of the components described above. The other additives are not particularly limited, and examples thereof include an emulsifier and a coloring material. The content of the other additives is not particularly limited, but is, for example, 0.1% to 5.0% by mass with respect to the total amount of the second aqueous adhesive composition.

### 1.2.7. Method of Producing Second Aqueous Adhesive Composition

A method of producing the second aqueous adhesive composition is the same as the method of producing the first aqueous adhesive composition except for the materials used.

### 2. Ink Jet Textile Printing Apparatus

The ink jet textile printing apparatus of the present embodiment includes a transport belt that transports a fabric and includes an adhesive layer containing the aqueous adhesive composition on a surface that is in contact with the fabric, and an ink jet head having a nozzle that ejects an ink to the fabric to be transported by the transport belt. In addition, the ink jet textile printing apparatus of the present embodiment may include a washing section that washes the adhesive layer after recording is carried out using the ink jet head and the fabric is peeled off from the adhesive layer.

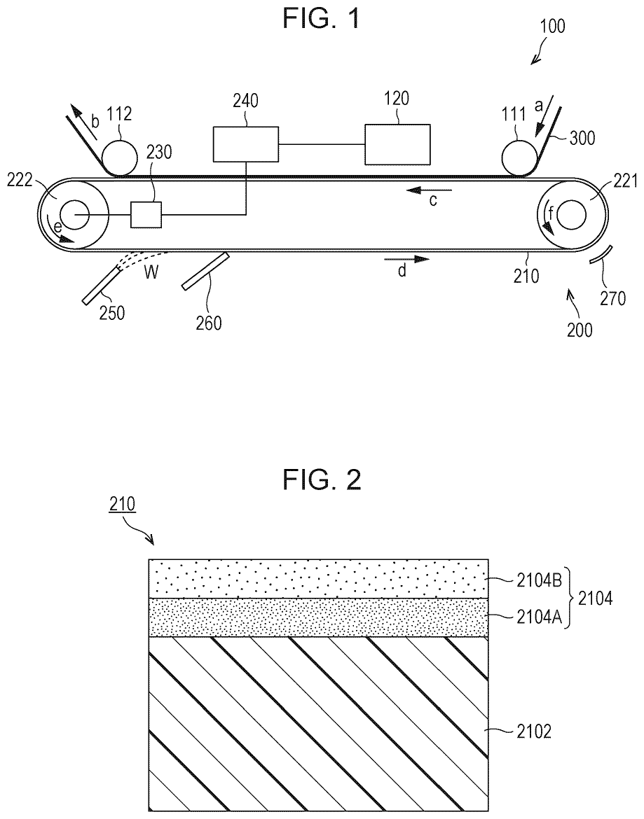

An ink jet textile printing apparatus 100 according to the present embodiment will be described with reference to FIG. 1. FIG. 1 is a configuration view showing the entire ink jet textile printing apparatus 100 including a transport device 200 according to the present embodiment. In FIG. 1, arrows a and b indicate a transport direction of a fabric 300 which is a recording medium. Arrows c and d indicate a rotation direction of a transport belt 210. Arrows e and f indicate a rotation direction of transport rollers 221 and 222.

The ink jet textile printing apparatus 100 may include a transport device 200 for attaching and transporting the fabric on the surface, fabric transport rollers 111 and 112, and a recording section 120. The fabric 300 coming from the direction a is pressed against the transport belt 210 by the fabric transport roller 111, and the fabric 300 is bonded to the surface of the transport belt 210.

The fabric 300 is transported to directly below the recording section 120 by the transport device 200 in a state where the fabric 300 is bonded to the surface of the transport belt 210, and the recording section 120 performs recording on the fabric 300. Thereafter, the transport belt 210 and the fabric 300 are peeled off from each other by the fabric transport roller 112.

The recording section 120 may be an ink jet head having a nozzle that ejects an ink to the fabric. In the present embodiment, the recording section 120 is assumed to use an ink jet type head to perform textile printing on the fabric 300, but the present disclosure is not limited thereto. For example, recording may be performed by analog textile printing such as hand textile printing or rotary textile printing. The transport belt including the adhesive layer that contains the above-described aqueous adhesive composition can also be suitably used in analog textile printing.

The transport device 200 may include a pair of transport rollers 221 and 222, the transport belt 210, a drive motor 230, a control device 240, a washing section 250, a removal member 260, and a heater 270.

The transport rollers 221 and 222 are rollers for transporting the transport belt 210 in a certain direction. FIG. 2 is a schematic cross-sectional view showing the transport belt of the present embodiment. As shown in FIG. 2, a transport belt 210 includes a transport member 2102, a first adhesive layer 2104A, and a second adhesive layer 2104B in this order, and the second adhesive layer 2104B may contain the second aqueous adhesive composition and the first adhesive layer 2104A may contain the first aqueous adhesive composition. The transport belt 210 transports the fabric in the direction indicated by the arrow c by rotating the transport rollers 221 and 222 using the drive motor 230. The transport belt 210 includes an adhesive layer 2104 having the first adhesive layer 2104A and the second adhesive layer 2104B on the surface that comes into contact with the fabric. It is not necessary that the entire second adhesive layer 2104B included in the adhesive layer 2104 is present on the first adhesive layer 2104A, and a part or the entirety of the second adhesive layer 2104B included in the adhesive layer 2104 may be present on the first adhesive layer 2104A. In addition, the second adhesive layer 2104B may form a surface that comes into contact with the fabric. The first adhesive layer 2104A may form a surface that comes into contact with the transport member 2102. Another layer may be present between the first adhesive layer 2104A and the second adhesive layer 2104B.

When the adhesive layer 2104 including the first adhesive layer 2104A and the second adhesive layer 2104B is formed at the transport member 2102, the fabric can be stably fixed during printing and can be prevented from being contaminated by the component peeled from the adhesive layer 2104. In addition, when the adhesive layer 2104 is washed, the surface of the adhesive layer 2104 can be prevented from being scratched or peeled off. Further, when the adhesive layer 2104 on the transport member 2102 is replaced, the adhesive layer 2104 tends to be suitably peeled off from the transport member 2102. Further, the adhesive layer 2104 can be formed without using an organic solvent, and the amount of organic solvent to be used can be reduced even when peeling. Therefore, it is not necessary to consider adverse effects on a human body, the environmental load, and the like during the use of the adhesive layer 2104.

The thickness of the first adhesive layer 2104A is preferably 30 to 100 μm. When the thickness thereof is 30 μm or greater, the film strength of the first adhesive layer 2104A is improved, and the easy replacement property of the adhesive layer tends to be further improved. In addition, when the thickness thereof is 100 μm or less, the adhesiveness between the first adhesive layer 2104A and the transport member 2102 tends to be sufficient. The thickness of the adhesive layer is not necessarily uniform, and can be calculated by the average of the thicknesses at a plurality of points of the first adhesive layer 2104A.

The thickness of the second adhesive layer 2104B is preferably 100 to 300 μm. When the thickness is 100 μm or greater, the adhesiveness of the second adhesive layer 2104B tends to be further improved. In addition, when the thickness thereof is 300 μm or less, the adhesiveness between the second adhesive layer 2104B and the fabric tends to be in an appropriate range. The thickness of the adhesive layer is not necessarily uniform, and can be calculated by the average of the thicknesses at a plurality of points of the second adhesive layer 2104B.

The adhesive layer 2104 may be formed by coating the surface of the transport member 2102 with the above-described aqueous adhesive composition and drying the aqueous adhesive composition. For example, the second adhesive layer 2104B may be formed by coating the surface of the transport member 2102 with the first aqueous adhesive composition, drying the first aqueous adhesive composition to form the first adhesive layer 2104A, coating the surface of the first adhesive layer 2104A with the second aqueous adhesive composition, and drying the second aqueous adhesive composition.

The coating method is not particularly limited, and examples thereof include blade coating, roll coating, spray coating, dip coating, and a method of manually applying by the aqueous adhesive composition using a brush or a roller. The drying temperature is not particularly limited, but is, for example, 10° C. to 60° C. In addition, the drying time is not particularly limited, but is, for example, 1 to 24 hours.

As the transport member 2102, an elastic material such as a resin is preferable, and examples of such a material include a urethane resin. A heater (not shown) that heats the transport belt 210 may be installed in the ink jet textile printing apparatus 100. Further, in the step of washing the transport belt 210, a water receiving section (not shown) that receives washing water, a brush (not shown) that cleans the transport belt 210, a sponge (not shown), and the like may be used.

The control device 240 may control any one or both of the transport device 200 and the ink jet textile printing apparatus 100.

The washing section 250 washes the surface of the transport belt 210 from which the fabric 300 is peeled off. The components of the fabric 300 adhering to the transport belt 210 during printing and a colorant for printing are washed by the washing section 250. The washing section 250 may include a pump (not shown), a water spray port, and a water spray pipe.

The removal member 260 removes water adhering to the transport belt 210 by the washing section 250. The removal member 260 is not particularly limited, and examples thereof include a blade. As a material of the blade, an elastic material is preferable. Further, from the viewpoint of wear resistance, polyurethane is preferable. The contact portion with the transport belt 210 may have a rectangular cross section, or may have a shape in which the tip is obliquely cut off.

The heater 270 may be provided downstream of the washing section 250 and upstream of the fabric transport roller 111 that performs a bonding step. When the adhesive layer is heated with the heater 270, the (meth)acrylic resin constituting the adhesive layer is softened, and the adhesive force tends to be further improved.

Examples of the fabric 300 include fabrics made of natural fibers such as silk, cotton, and wool or synthetic fibers such as rayon, nylon and polyester. In addition, the fabric may be a woven fabric, a knitted fabric, a nonwoven fabric, or the like.

### 3. Ink Jet Textile Printing Method

An ink jet textile printing method of the present embodiment includes a transport step of transporting a fabric by bonding the fabric to an adhesive layer containing the aqueous adhesive composition formed at a surface of a transport belt of an ink jet textile printing apparatus, a recording step of performing textile recording on the fabric attached to the adhesive layer by using an ink jet head, and a washing step of washing the adhesive layer from which the fabric is peeled off after the textile recording.

### 3.1. Transport Step

The transport step is a step of transporting a fabric by bonding the fabric to the adhesive layer containing the aqueous adhesive composition, which is formed at the surface of the transport belt of the ink jet textile printing apparatus. The bonding method is not particularly limited, and examples thereof include a bonding method of pressing both the fabric and the adhesive layer using transport rolls as shown in FIG. 1.

### 3.2. Recording Step

The recording step is a step of performing textile recording on the fabric attached to the adhesive layer using an ink jet head. In the recording step, the fabric is transported in a state where the transport belt and the fabric closely adhere to each other via the adhesive layer on the surface of the transport belt, and the ink adheres to the fabric by being ejected from the recording section 120 in the process of transport of the fabric. Next, the fabric to which the ink has adhered may be peeled off from the adhesive layer and recovered.

### 3.3. Washing Step

The washing step is a step of washing the adhesive layer from which the fabric is peeled off after the textile recording. Dust such as lint derived from the fabric having adhered to the adhesive layer in the recording step can be removed from the surface of the adhesive layer by the washing step.

### EXAMPLES

Hereinafter, the present disclosure will be described in more detail with reference to examples and comparative examples. The present disclosure is not limited to the following examples. In addition, each operation in the examples was performed in an environment of room temperature (25° C.) and 1 atm unless otherwise specified.

### 1. Production of Aqueous Dispersion of Resin

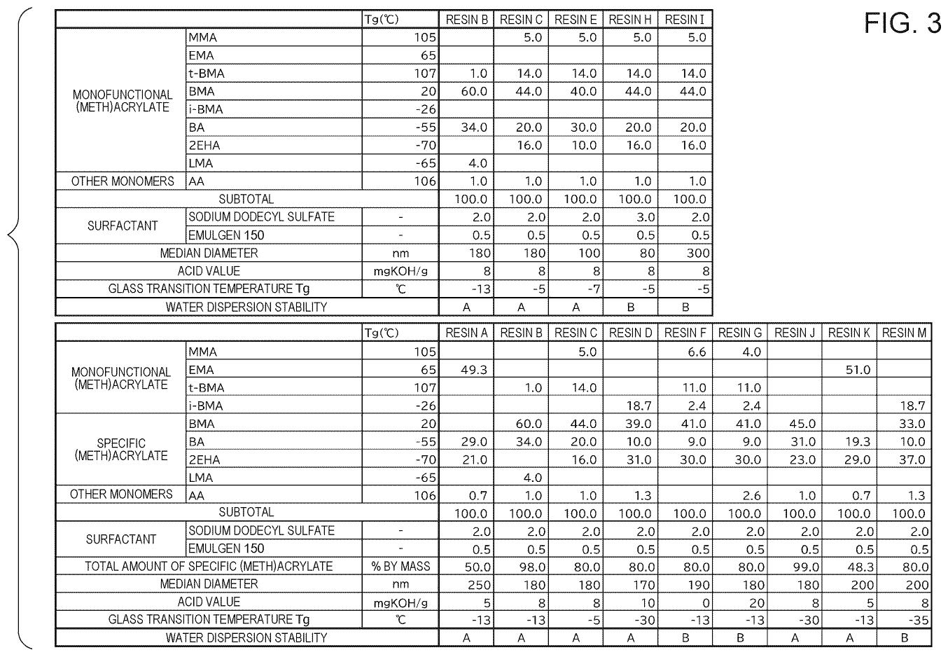

235 g of ion exchange water was added to a reactor provided with a stirrer, a reflux cooling tube, a thermometer, a nitrogen introduction tube, and a dropping funnel, and was heated to 82° C. Thereafter, a total of 490 g of monomers weight to have the compositional ratio shown in FIG. 3, 140 g of ion exchange water, 2.5 g of EMULGEN 150 (manufactured by Kao Corporation) serving as a surfactant, and 9.8 g of sodium dodecyl sulfate were added, mixed, and stirred. 98 g of a 5 mass % aqueous solution of ammonium persulfate as a polymerization initiator was added to the uniform solution at 82° C. over 1.5 hours.

The solution to which all the above-described types of substances had been added was maintained warm for 1 hour and cooled, and ion exchange water and ammonia water serving as a pH adjuster were added thereto to adjust the pH to 8 or greater and 9 or less. Thereafter, the coarse particles were removed by filtering through a 150-mesh nylon filter, thereby obtaining an aqueous dispersion of a resin including resins A to K and M having the composition shown in FIG. 3 (solid content of 50% by mass). The amount of each component used in FIG. 3 is in units of % by mass (mass of the solid content) with respect to the total amount of monomers. In addition, the glass transition temperature of each monomer shown in FIG. 3 denotes the glass transition temperature of the homopolymer of the monomer. The glass transition temperature of the homopolymer can be obtained from the safety data sheet (SDS) or catalog information of the monomer.

Each of the monomers regarding the constitutional units of the (meth)acrylic resins shown in FIG. 3 is as follows.
MMA: methyl methacrylate
EMA: ethyl methacrylate
t-BMA: tert-butyl methacrylate
BMA: butyl methacrylate
i-BMA: isobutyl methacrylate
BA: butyl acrylate
2EHA: 2-ethylhexyl acrylate
LMA: lauryl methacrylate
AA: acrylic acid

### 2. Measurement of Physical Properties

### 2.1. Glass Transition Temperature

The glass transition temperature Tg was measured in conformity with JIS K 7121, and the value obtained by the measurement using a differential scanning calorimeter “DSC8000” (manufactured by PerkinElmer, Inc.) was listed in the columns of “glass transition temperature Tg” in FIG. 3.

### 2.2. Median Diameter

The particle diameter (median diameter) is a value of D50 obtained by measurement using a zeta potential/particle diameter measurement system “ELSZ-1000ZS” (manufactured by Otsuka Electronics Co., Ltd.). The measurement results are listed in the columns of “median diameter” in FIG. 3.

### 2.3. Acid Value

The acid value was measured in conformity with JIS K 2501. The measurement results are listed in the columns of “acid value” in FIG. 3.

### 4. Evaluation Results

### 4.1. Adhesiveness

An aqueous dispersion of a resin including a resin B, C, E, H, or I and an aqueous dispersion of a resin including a resin A, B, C, D, F, G, J, K or M were used as the aqueous adhesive compositions respectively.

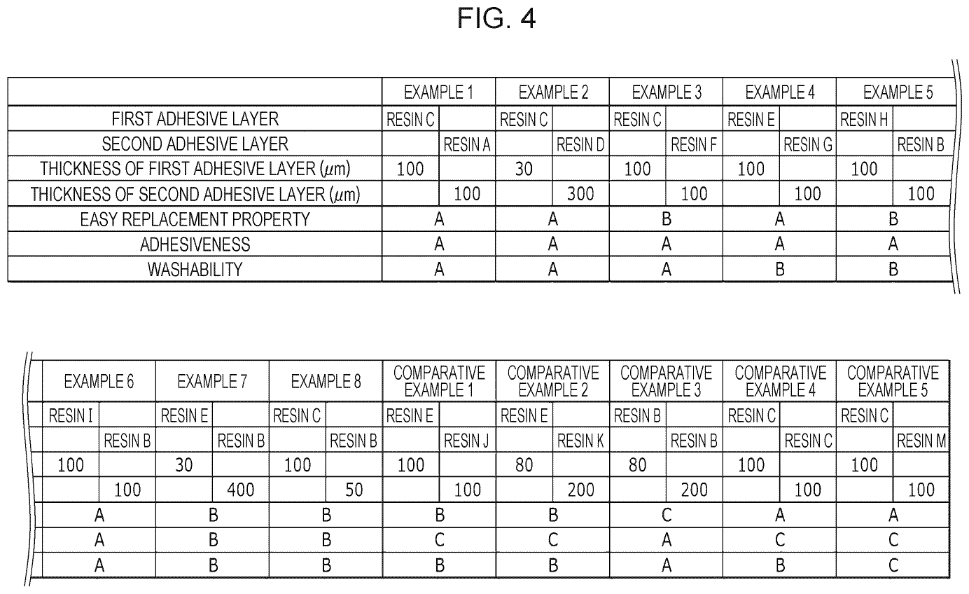

A glass plate was coated with the aqueous adhesive composition containing the resin shown in FIG. 4, and the aqueous adhesive composition was dried to form a first adhesive layer having the thickness shown in FIG. 4. Thereafter, the first adhesive layer was coated with the aqueous adhesive composition containing the resin shown in FIG. 4, and the aqueous adhesive composition was dried to form a second adhesive layer having the thickness shown in FIG. 4. In this manner, adhesive layers of each example were formed at the glass plate. Further, the aqueous adhesive composition was dried under drying conditions of a relative humidity of 25%, a temperature of 50° C., and a drying time of 30 minutes.

Cotton having a width of 50 mm was roll-pressed on the adhesive layer at a pressure of 1 kgf/50 mm. Thereafter, a 180° peeling force was measured in an environment of 23° C. by performing a 180° peeling test. The measurement results were evaluated according to the following criteria.

### Evaluation Criteria

A: 1.0 N/50 mm or greater and less than 5.0 N/50 mm
B: 0.1 N/50 mm or greater and less than 1.0 N/50 mm
C: less than 0.1 N/50 mm or 5.0 N/50 mm or greater

### 4.2. Washability

An adhesive layer was formed in the same manner as in the evaluation of the adhesiveness. A nylon brush wet with water was rotated at 200 rpm and pressed against the adhesive layer with a pressure of 1.0 N/cm. After 200 hours since the start of the pressing, the surface of the adhesive layer was visually observed, and the evaluation was performed according to the following criteria. As the nylon brush, a brush made of 6/10 nylon having a bristle diameter of 0.3 mm, a bristle length of 30 mm, and a brush diameter of 16 mm was used.

### Evaluation Criteria

A: No scratch is observed.
B: Slight scratches are observed.
C: Unevenness is observed.

### 4.3. Easy Replacement Property

An adhesive layer was formed in the same manner as in the evaluation of the adhesiveness except that a urethane belt was used instead of the glass plate. The adhesive layer was immersed in an ethanol aqueous solution containing 60% by mass of ethanol for 1 hour. Thereafter, the adhesive layer was peeled off from the belt, and the evaluation was performed according to the following criteria.

### Evaluation Criteria

A: The adhesive layer is clearly peeled off.
B: The adhesive sheet is clearly peeled off even though the peeling takes some time.
C: The adhesive layer is not clearly peeled off.

### 4.4. Water Dispersion Stability

100 g of the aqueous dispersion of the resin including resins A to K and M was added to a 200 mL glass bottle and allowed to stand at 50° C. for 2 weeks. Thereafter, the aqueous dispersion of each resin was visually observed, and the evaluation was performed according to the following criteria.

### Evaluation Criteria

A: Thickening, aggregation, and precipitation are not observed.
B: At least one of thickening, aggregation, and sedimentation occurs.

What is claimed is:

1. A set of aqueous adhesive compositions for forming an adhesive layer on a surface of a transport member of an ink jet textile printing apparatus, which transports a fabric, the set comprising:
a first aqueous adhesive composition; and
a second aqueous adhesive composition, wherein
the adhesive layer includes a first adhesive layer laminated on the transport member and containing the first aqueous adhesive composition, and a second adhesive layer laminated on the first adhesive layer and containing the second aqueous adhesive composition,
the second aqueous adhesive composition contains water and a second (meth)acrylic resin,
the second (meth)acrylic resin has 50% to 98% by mass of a constitutional unit derived from a specific (meth)acrylate represented by Formula (1) with respect to a total amount of the second (meth)acrylic resin,
the second (meth)acrylic resin has a glass transition temperature of −30° C. to −7° C.,
the first aqueous adhesive composition contains water and a first (meth)acrylic resin, and
the first (meth)acrylic resin has a glass transition temperature higher than the glass transition temperature of the second (meth)acrylic resin, 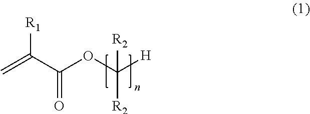
(in Formula (1), R₁ represents a hydrogen atom or a methyl group, a plurality of R₂'s each independently represent a hydrogen atom, a methyl group, or an ethyl group, and n represents a natural number of 4 to 12).

2. The set of aqueous adhesive compositions according to claim 1, wherein
the first (meth)acrylic resin has a glass transition temperature of −7 to 0° C.

3. The set of the aqueous adhesive compositions according to claim 1, wherein
the second (meth)acrylic resin contains a carboxyl group, and
the second (meth)acrylic resin has an acid value of 5 to 10 mg KOH/g.

4. The set of aqueous adhesive compositions according to claim 1, wherein
the second aqueous adhesive composition contains resin particles containing the second (meth)acrylic resin, and
the resin particles have a particle diameter of 100 to 250 nm.

5. A transport belt comprising in the following order:
a transport member;
a first adhesive layer; and
a second adhesive layer, wherein
the second adhesive layer contains a second aqueous adhesive composition,
the second aqueous adhesive composition contains water and a second (meth)acrylic resin,
the second (meth)acrylic resin has 50% to 98% by mass of a constitutional unit derived from a specific (meth)acrylate represented by Formula (1) with respect to a total amount of the second (meth)acrylic resin,
the second (meth)acrylic resin has a glass transition temperature of −30° C. to −7° C.,
the first adhesive layer contains a first aqueous adhesive composition,
the first aqueous adhesive composition contains water and a first (meth)acrylic resin, and
the first (meth)acrylic resin has a glass transition temperature higher than the glass transition temperature of the second (meth)acrylic resin, 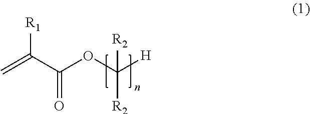
(in Formula (1), R₁ represents a hydrogen atom or a methyl group, a plurality of R₂'s each independently represent a hydrogen atom, a methyl group, or an ethyl group, and n represents a natural number of 4 to 12).

6. The transport belt according to claim 5, wherein
the first adhesive layer has a thickness of 30 to 100 μm.

7. The transport belt according to claim 5, wherein
the second adhesive layer has a thickness of 100 to 300 μm.
